(19) United States
(12) Patent Application Publication
(10) Pub. No.: US 2010/0138523 A1
(43) Pub. Date: Jun. 3, 2010

(54) AUTOMATIC CONFIGURATION METHOD AND SYSTEM FOR MEDICAL DEVICES

(75) Inventors: Mark Steven Urness, Wauwatosa, WI (US); Andrew Stonefield, Whitefish Bay, WI (US)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 12/327,059

(22) Filed: Dec. 3, 2008

(51) Int. Cl. G06F 15/177

(52) U.S. Cl. 709/222

(57) ABSTRACT

An automatic configuration method and system for medical devices in a healthcare network is disclosed herewith. The method comprises: installing a medical device in a healthcare network. Upon installation, the medical device accesses a server for obtaining configuration information of at least one client in the network. The medical device automatically configures the clients with the medical device, using the obtained configuration information.

### FIELD OF THE INVENTION

This invention relates generally to establishing communication between various devices in a healthcare network. More specifically, the invention provides methods and systems for automatically configuring different clients in a healthcare network with a medical device.

### BACKGROUND OF THE INVENTION

In various medical diagnostic applications, it is required to store the diagnostic information or diagnostic images in a permanent storage media. Most of the diagnostic systems including medical imaging systems are configured to send the image data to an external device for storing the image data in the external device. Hence, modern imaging systems need to be able to transfer images to various types of external devices via a communication network. To successfully transfer images, the relevant networking features of the imaging system must be compatible with the networking features of the external devices. For this, relevant configuration information of the external devices needs to be provided to the imaging system.

Since the images need to be stored in external devices, it is necessary to configure these external devices with the imaging system. Generally, this is done at the time of installation of the imaging system. To establish a communication between the imaging system and the external devices via DICOM or windows networking, a large amount of data has to be entered into the imaging system and into the external devices. The DICOM standards are intended for use in communicating medical digital images among printers, workstations, acquisition modules and file servers. In particular, the imaging system should identify the operating parameters and configuration information of different devices available in the healthcare network. Thus these external devices need to be identified and configured with the imaging system to establish a communication between them and thereby enable the storage of the images in the external devices.

Once the imaging system is installed, a field engineer visits the site of installation and configures the external devices present in the network with the imaging system. At the install, the customer's information technology (IT) department or some one who knows the connectivity or configuration information of the external devices should be available to provide the connectivity information to the field engineer. Many times, the field engineer may not have an idea about the configuration information corresponding to various devices present in the network. Unfortunately, the customer may not always have an IT person available to provide connectivity data. Some times, the field engineer may copy the configuration information of these devices from another imaging system that already exists in the network and may use the same to configure the devices with the newly installed system. Also, in the event of an update in the configuration information, the field engineer or the user has to manually update the same.

Some of the solutions suggest providing template-based configuration information, wherein different devices available in a network and their configuration information are stored into the hard disc of the imaging system. As and when a device needs to be configured, the configuration information is retrieved from the system hard disc and the same is used.

Further currently, the back up of all the configuration information including device-setting parameters, are done manually. The user is responsible for taking the backup and updating the same as and when there is a change in the configuration information. Unfortunately, manual back up is not always performed in a timely fashion.

Thus there exists a need to provide a method and system for automatically configuring various devices in a healthcare network.

### SUMMARY OF THE INVENTION

The above-mentioned shortcomings, disadvantages and problems are addressed herein which will be understood by reading and understanding the following specification.

An embodiment of the invention provides a method of establishing communication between a medical device and various clients in a healthcare network. The method comprises: installing a medical device in a healthcare network; the medical device accessing a server for obtaining configuration information of at least one client in the network; and configuring the client with the medical device, using the obtained configuration information.

In another embodiment, a method of configuring various clients with an ultrasound imaging device is disclosed. The method comprises: installing an ultrasound imaging device in a healthcare network and identifying the ultrasound imaging device in the network. The ultrasound imaging device communicates with a server having a database stored with configuration information corresponding to various clients in the healthcare network and the configuration information of at least one desired client for the ultrasound imaging device is obtained from the server. The desired clients with the ultrasound imaging system are configured with the ultrasound imaging device using the configuration information.

In yet another embodiment, an automatic configuration method is disclosed. The method comprises: storing and updating a database with configuration information corresponding to plurality of clients in a healthcare network; remotely accessing the database by a medical device in the same network to retrieve configuration information corresponding to at least one desired client; and establishing a communication between the medical device and the desired clients using the configuration information, upon initiating the medical device or the client in the network.

In yet another embodiment, an automatic configuration system is provided. The system comprises: a medical device in a healthcare network having a communication interface configured to allow communication between the medical device and a server; plurality of clients in the healthcare network that need to be configured with the medical device; and a storage medium associated with the server configured to store configuration information corresponding to the clients. The medical device configures at least one client to the medical device by accessing the storage medium for automatically retrieving configuration information of the clients, upon installation of the medical device.

In yet another embodiment, an ultrasound imaging device comprising an imager, computer or processor, memory, and a display, the device configured to: automatically configure at least one client in a healthcare network to the ultrasound imaging device in the same network is disclosed. The device comprises: a communication interface for establishing a communication with a server having a database stored with configuration information corresponding to various clients in the network; and a configuration module for configuring the clients with the ultrasound imaging device using the configuration information retrieved from the server.

Various other features, objects, and advantages of the invention will be made apparent to those skilled in the art from the accompanying drawings and detailed description thereof.

### BRIEF DESCRIPTION OF THE DRAWINGS

FIG. 1 is a flowchart illustrating a communication method as described in an embodiment of the invention;

FIG. 2 is a flowchart illustrating a method of configuring various devices to an ultrasound imaging device as described in an embodiment of the invention;

FIG. 3 is a flowchart illustrating an automated configuration method as described in an embodiment of the invention;

FIG. 4 is a detailed flowchart illustrating a configuration method as described in an embodiment of the invention;

FIG. 5 is a block diagram illustrating an automated configuration system as described in an embodiment of the invention;

FIG. 6 is a block diagram illustrating an ultrasound imaging device as described in an embodiment of the invention;

FIG. 7 is a schematic representation of a hospital information system (HIS) having automated configuration facility, as described in an embodiment of the invention;

FIG. 8A to 8F is a schematic diagram illustrating an automatic configuration method as described in an embodiment of the invention; and

FIG. 9A to 9F is a schematic diagram illustrating another embodiment of an automatic configuration method.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

Various embodiments of the present invention are directed to methods and systems for automatically configuring various devices in a healthcare network to establish a communication among them. In an embodiment, the configuration information corresponding to various devices is stored in a database in a remote server. At the time of installation of a device, the configuration information corresponding to other devices on the network are automatically retrieved from the server.

In an exemplary embodiment, a method of automatically configuring an image-storing device such as a Picture Archiving and Communications System (PACS), Electronic Medical Record (EMR), Radiology Information System (RIS), review station, printer etc in a healthcare network to an ultrasound imaging device is disclosed. The configuration information is provided upon installing the ultrasound imaging device in the same healthcare network. Alternately, the configuration information may be provided to the ultrasound imaging device upon detecting a change in the configuration information of the image storing devices. The image storing device may include DICOM complaint as well as non-DICOM devices.

In an embodiment, a method of automatically updating and taking a back up of configuration information is disclosed. Various clients in a healthcare network are configured to update the database in the server upon any changes in the configuration. The server will automatically send these updates to relevant clients in the network.

Although the invention is explained with reference to ultrasound imaging devices, the application of the invention may be extended to any medical devices present in a healthcare network that need to be configured to any DICOM or non-DICOM devices present in the same network. The medical devices may include medical diagnostic devices such as Magnetic Resonance Imaging (MRI) system, a computed Tomography (CT) system, and X-Ray imaging devices. The medical device includes any DICOM complaint device present in the healthcare network. The clients present in the network need not be limited to image storing or processing devices, as mentioned in some of the examples. The client could include DICOM and non DICOM devices performing operations like image management, image viewing, processing, image storing, image acquisition etc. The term “Client” may not be interpreted as singular, unless otherwise specified. The healthcare network may include a hospital network a hospital network achieved via a Local Area Network (LAN), a Wide Area Network (WAN), a Metropolitan Area Network (MAN), a Wireless LAN (WLAN), and a Virtual Private Network (VPN).

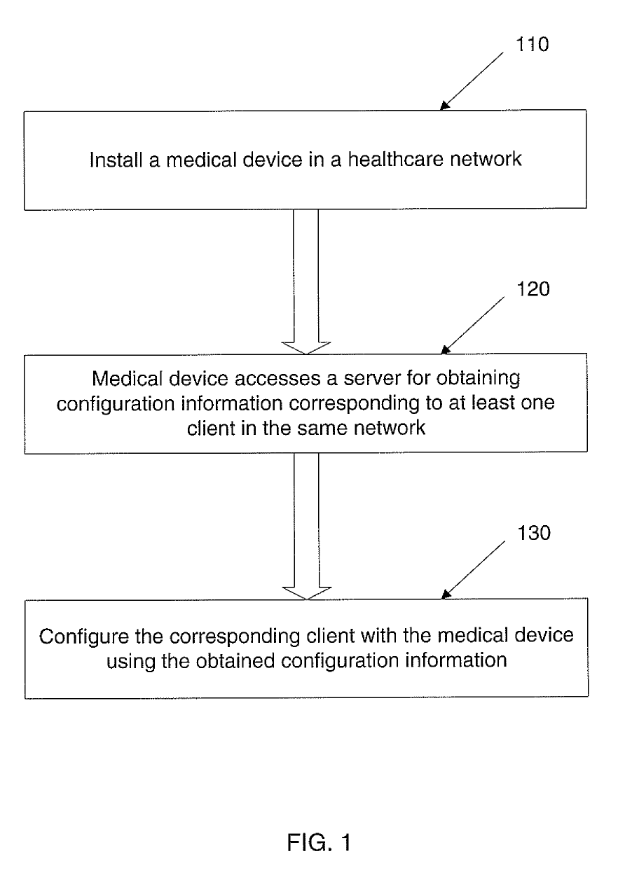

FIG. 1 is a flowchart illustrating a communication method as described in an embodiment of the invention. In a healthcare network, there exist many electronic devices, referred to as clients hereinafter, and a medical device needs to interact with them effectively to achieve various functionalities. To establish a communication between the medical device and the clients present in the network, these clients need to be configured with the medical device. In case of a DICOM device, information such as Application Entity (AE) Title, port number, Internet Protocol (IP) address etc need to be exchanged for establishing communication between them. In an embodiment, the configuration information corresponding to each client is stored in a database in a server.

At step 110, a medical device is installed in a healthcare facility. Upon installation, identification information such as an IP address is provided to the medical device to qualify as a client in a healthcare network. At step 120, the medical device accesses a server to obtain configuration information corresponding to at least one client available in the same healthcare network. The configuration information corresponding to all clients including the medical device is stored in a database in the server. In an example, the server could be located remotely. The medical device may communicate with the server through a communication link using the IP address of the medical device. The server identifies the IP address of the medical device and establishes a communication between them. Once the IP address or the medical device is identified, the server may automatically identify, desired clients that need to be configured with the medical device. Alternately, the medical device may automatically or manually identify the desired clients in the network and request for the corresponding configuration information from the server. The medical device or clients in the network may use Dynamic Host Configuration Protocol (DHCP) to receive IP addressing configuration for initial communication to the healthcare network. Once able to communicate on the healthcare network, the medical device or clients initiate communication to the server to receive the supplemental configuration parameters for communication to other clients or medical devices on the healthcare network. In an embodiment, the clients may be identified in the server database by AE Title.

Alternately, upon identifying the medical device, the server may identify configuration updates for the medical device. If there is an update, the updated configuration information is automatically sent to the medical device. Alternately, the server may identify a change in configuration information of the medical device and communicate the same automatically to desired clients. The server may identify the desired clients on IP address, AE Title, hostname, or Media Access Control address (MAC address).

Thus the configuration information corresponding to the desired clients are obtained from the server and sent to the medical device automatically. The configuration information corresponding to the desired clients may be sent to the ultrasound imaging system through a wireless or wired communication link. At step 130, the clients are configured with the medical device based on the configuration information. Once the configuration information is provided to the medical device, the medical device may automatically configure the clients. Alternately, a field engineer or any other technician may configure the clients with the medical device using the configuration information obtained from the server.

In an embodiment, the configuration information might include configuration workflows for clients and the medical device, configuration updates, client and medical device operating parameters, connectivity settings, and medical device and client device settings etc. However the list of configuration information need not be limited to this, the configuration information could include any information that is helpful in establishing communication between various devices in a healthcare network and facilitating communication among them for achieving one or more desired services/functionalities.

In an embodiment, the server might be a remote server. The medical device may interact with the server through a wireless communication link.

In an embodiment, the medical device and the clients may co locate in a hospital facility. Alternately, the medical device and the clients may be located at different location, but still may be a part of the same healthcare network.

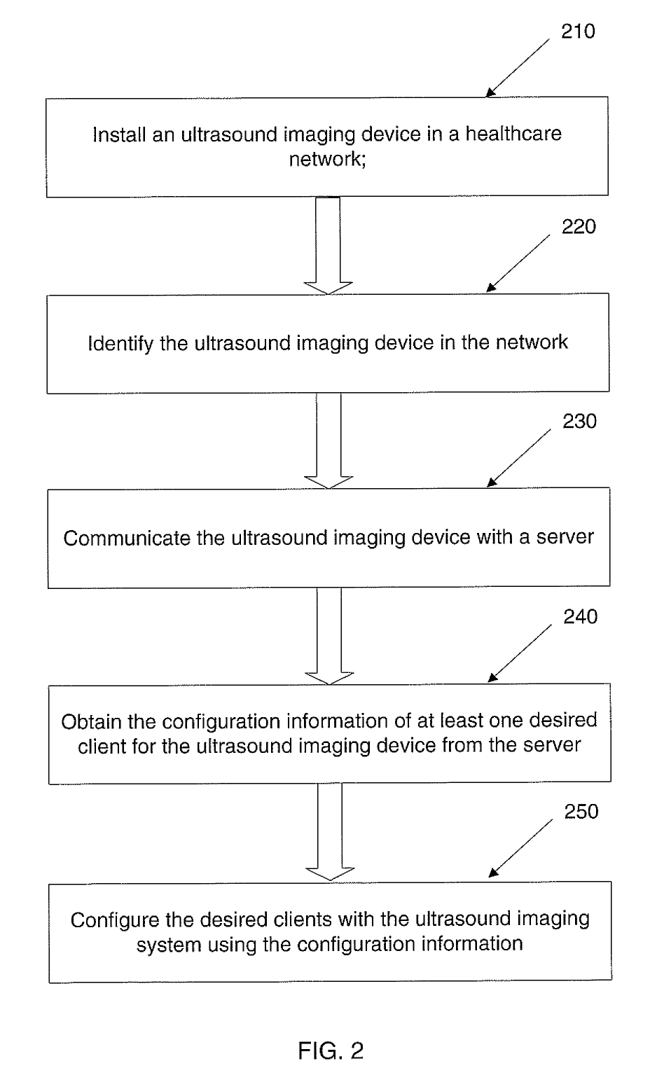

FIG. 2 is a flowchart illustrating a method of configuring various devices to an ultrasound imaging device as described in an embodiment of the invention. At step 210, an ultrasound-imaging device is installed in a hospital environment. Various other devices and systems in the hospital may be in a healthcare network. Once the ultrasound imaging device is installed, the ultrasound imaging device enters into the healthcare network as at step 210. This is achieved by providing an IP address to the ultrasound imaging device. Once the IP address is obtained, the ultrasound imaging device may start communicating with the server, as at step 230. In an example, the server identifies the IP address of the ultrasound imaging device and establishes a communication between them. In the absence of manual configuration information, the ultrasound imaging device queries the server for configuration information. The server identifies the desired clients of the ultrasound imaging device and corresponding configuration information is sent to the ultrasound imaging device. Alternately, the desired clients may be identified by the ultrasound imaging device from the network and identification information corresponding to the desired clients may be sent to the server. Thus at step 240, the configuration information corresponding to the desired clients is obtained by the ultrasound imaging device, automatically. At step 250, the configuration information is used to configure various clients with the ultrasound imaging device. The configuration information may include IP address, AE Title, Port number, etc of the clients such as PACS, printer, review workstation, EMR, RIS etc.

In an embodiment, the ultrasound imaging device is configured to communicate to the server about any change in its configuration information. For example, if the IP address of the ultrasound imaging device changes for some reason, the change is communicated to the server. The server automatically communicates this information to all the clients and the clients may update the configuration information of the ultrasound imaging device with the new IP address of the ultrasound imaging device.

Alternately, the configuration information of the client might change. For example, the device setting parameters of PACS may change. The PACS communicates this to the server and the server may automatically send this information to the ultrasound imaging device. The ultrasound imaging device may incorporate these changes within the device.

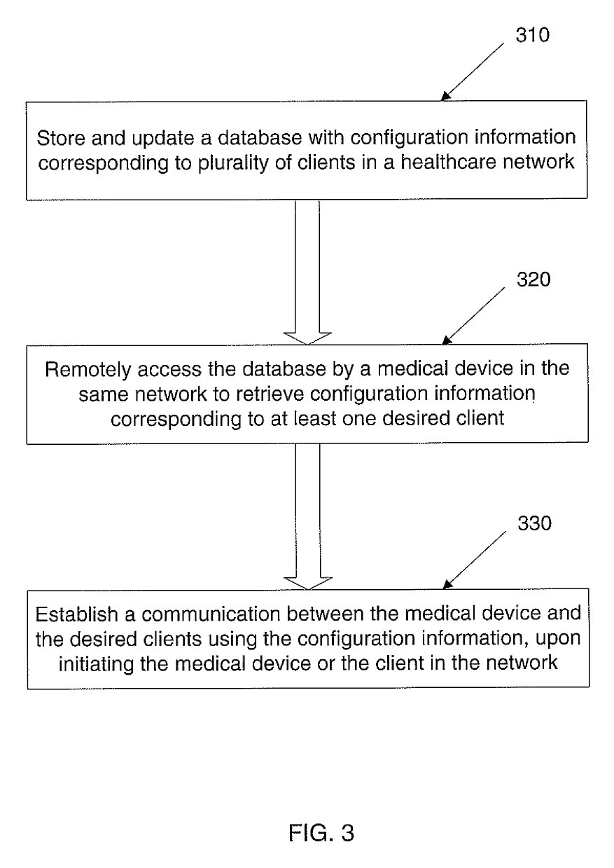

FIG. 3 is a flowchart illustrating an automated configuration method as described in an embodiment of the invention. At step 310, a database is stored and updated with configuration information corresponding to plurality of clients in a healthcare network. The database may be located in a server. The clients in the network can interact with the database through a communication link. The clients update their configuration information automatically within the database. In an embodiment the database might contain identification information of all the clients present in the healthcare network along with their configuration information. The identification information might include, IP number, AE title etc. Initially an administrator may generate a database with the information corresponding to all clients in the healthcare network. As and when there is an update in the configuration information, the administrator manually or the clients automatically may update the database. Thus, the database may be any of a variety of memory components, which allow for the reading and writing of non-volatile data, such as, battery-backed RAM (random access memory), EPROM (electrically programmable read only memory) and EEPROM (electrically-erasable programmable read only memory).

At step 320, a medical device in the same healthcare network is configured to access the database remotely to retrieve configuration information corresponding to at least one client. The database is stored with the configuration information of all the clients in the healthcare network. In an embodiment, the server may identify the desired clients for the medical device. Alternately, the medical device may specify the desired clients. The configuration information corresponding to the desired clients is retrieved from the server and sent to the medical device.

At step 330, a communication is established between the medical device and at least one desired client. The configuration information corresponding to the desired client is retrieved from the database upon initiating the medical device or client in the network. In an embodiment, as and when the medical device is installed, the medical device may search for manual configuration information and in the absence of the same, the medical device may query the server for configuration information. In another embodiment, upon initializing or powering on the medical device, the medical device may query the server for any configuration information or updates and the server may automatically send the configuration information to the medical device. In another embodiment, the client may change its configuration information and the same may be updated in the database. Upon initiating the medical device, the updated configuration information may be automatically sent to the medical device. In another embodiment, the medical device may change its configuration information and upon initiating the clients, the changes in the configuration information of the medical device may be sent to the desired clients.

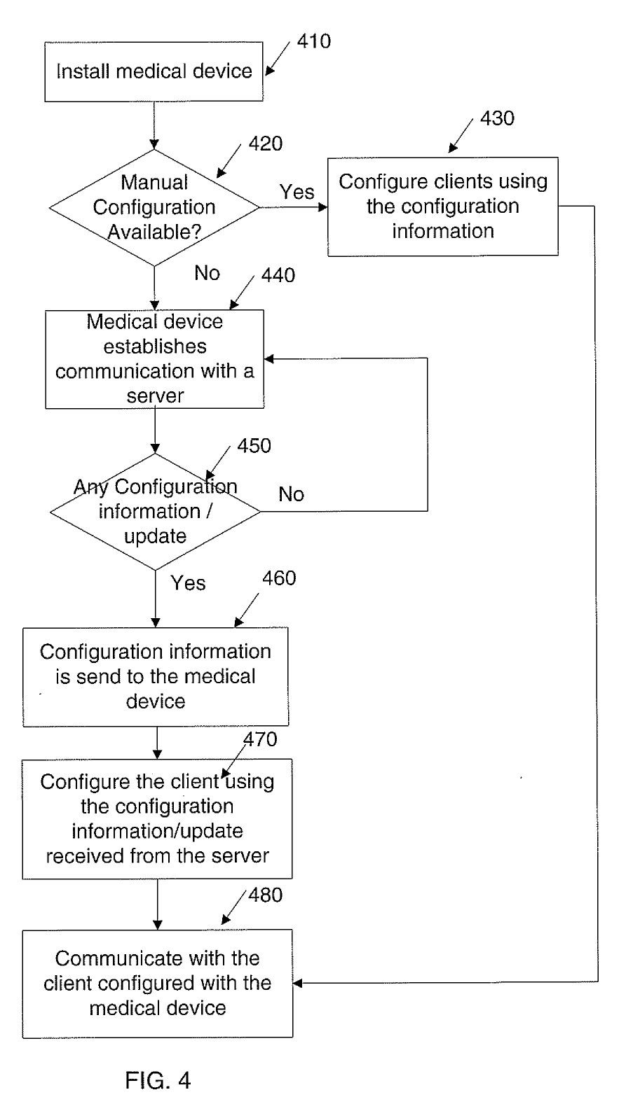

FIG. 4 is a detailed flowchart illustrating the configuration method as described in an embodiment of the invention. At step 410, a medical device is installed. If the medical device is newly installed, then the configuration information includes the initial configuration information. In the event of initializing or powering on a medical device, which is already configured with various clients, the configuration information includes any update in the configuration information. Upon installing the medical device in network, the medical device will look for the manual configuration information as at step 420. If manual configuration information is available, the medical device may configure the clients using the manual configuration information, as at step 430. The manual configuration information may be provided by an administrator or may be taken from a template-based format, which is stored in the hardware of the medical device. If the manual configuration is not available, the medical device establishes a communication with a server, as at step 440. The server is configured to have a database stored with configuration information corresponding to all the clients present in the network. Before establishing the communication, the server may identify the medical device in the network and authorize the same to communicate with the server. At step 450, the medical device configures the server for any configuration information or any updates. If the configuration information/update is available for a client relevant to the medical device, the same is send to the medical device. The server identifies the desired client along with the corresponding configuration information from the database and communicates the same with the medical device, as at step 460. At step 470, the medical device configures the clients based on the configuration information or updates received from the server. At step 480, the medical device may establish communication with its relevant/desired clients.

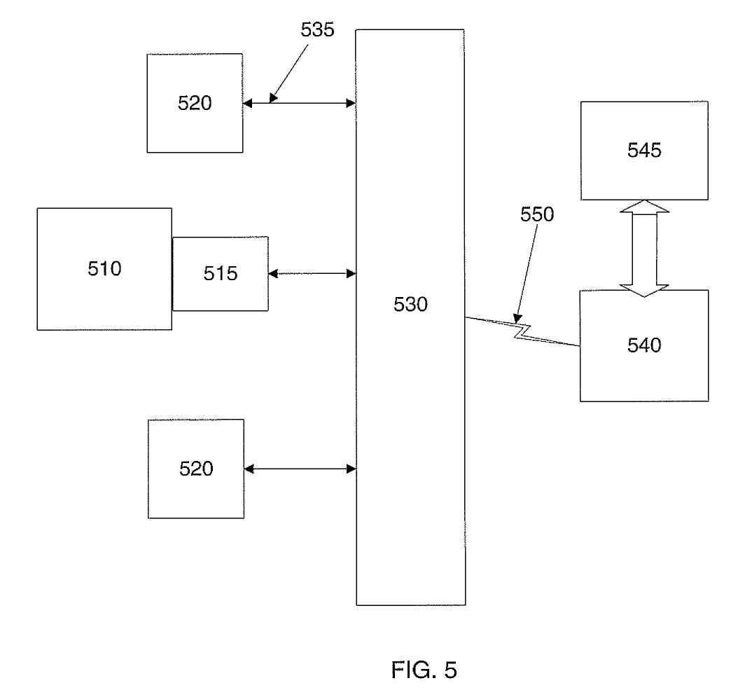

FIG. 5 is a block diagram illustrating an automated configuration system as described in an embodiment of the invention. The automated configuration system includes a medical device 5 10 along with plurality of clients 520 available in a healthcare network 530. The medical device 510 may be any DICOM device including medical diagnostic devices. The client 520 may include DICOM and non-DICOM devices such as medical image processing devices, image storing devices etc. The clients 520 and the medical device 510 need not be limited to the examples mentioned above. The medical device 510 is configured to include a communication interface 515. The communication interface 515 is configured to interact with the clients 520 in the network 530. The communication interface 515 may help in facilitating wired or wireless communication in the healthcare network 530. In an embodiment, the communication interface 515 may be a port, configured to connect the medical device 510 to the healthcare network 530. The healthcare network 530 may include network defined by LAN or WAN in a healthcare facility. The medical device 510 and the clients 520 need not be located in the same floor or building, but is a part of the same healthcare network 530. The medical device 510 and the client 520 may communicate in the network 530 through a data link 535. The data link 535 facilitates wired and wireless interaction in the network 530. The clients 520 may communicate in the network 530 through the data link 535. The data link 535 may be a serial interface, a RS232 line, or any other communication connection.

Once the medical device 510 is installed or initiated in the healthcare network 530, the medical device 510 interacts with a server 540 to obtain configuration information corresponding to various clients 520 in the network 530. The server 540 is configured to have a database 545 stored with configuration information and identification information corresponding to all the clients 520 present in the healthcare network 530. The database 545 may be stored in a memory device. The memory may include, for example, random access memory (RAM), flash memory, or read-only memory. For purposes of simplicity, devices that can read and/or write media on which computer programs are recorded are also included within the scope of the term “memory.” A non-exhaustive list of media that can be read with such a suitable device includes CDs, CD-RWs, DVDs of all types, magnetic media (including floppy disks, tape, and hard drives), flash memory in the form of sticks, cards, and other forms, ROMs, etc., and combinations thereof.

In an embodiment, the server 540 may be located within the network 530. Alternately, the server 540 may be located remotely. The medical device 510 communicates with the remote server 540 using a communication link 550. The communication link 550 might include any suitable network connection employed. Presently preferred network configurations include both proprietary or dedicated networks, as well as open networks, such as the Internet. Data may be exchanged between the medical device 510, clients 520 and the server 540 in any suitable format, such as in accordance with the Internet Protocol (IP), the Transmission Control Protocol (TCP), or other known protocols. Moreover, certain of the data may be transmitted or formatted via markup languages such as the HyperText Markup Language (HTML), or other standard languages.

Once the medical device 510 is installed, it communicates with the server 540 through the communication link 550. The medical device 510 sends its identification information such as IP address to the server 540. The server 540 identifies the medical device 510 and establishes a communication between them.

The medical device 510 may identify the desired clients 520 from the healthcare network 530 or an administrator may manually suggest the desired clients 520. In that event, the medical device 510 communicates the client identification information to the server 540 and from the database 545 the corresponding configuration information is conveyed to the medical device 510. Alternately, the database 545 may have the information about the desired clients 520 for the medical device 510. Upon identifying the medical device 510, the database 545 may identify the desired clients 520 and send the corresponding configuration information to the medical device 5 10.

For example, if the medical device 510 is an imaging system, upon communicating the IP address of the imaging system, the server 540 identifies the imaging device and identifies the specification such as make and model and other connectivity requirements of the medical device. Based on that, desired clients 520 may be selected with the help of a look up table. For an imaging device, clients such as PACS, printer, EMR etc may be selected.

The configuration information may be communicated from the server 540 to the medical device 510 through the communication link 550. The medical device 510 interacts with the clients 520 in the network 530 using the configuration information and the clients 520 are configured with the medical device 510. Once the clients 520 are configured with the medical device 510, communication can be established among them.

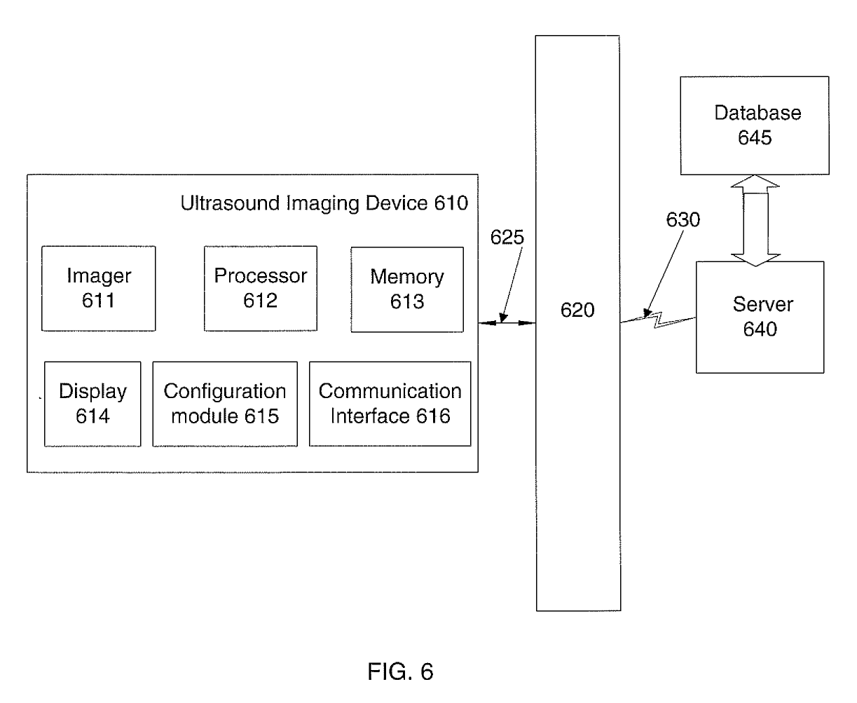

FIG. 6 is a block diagram illustrating an ultrasound imaging device as described in an embodiment of the invention. The ultrasound imaging device 610 comprises: an imager 611, processor 612, memory 613 and a display 614. The imager 611 is configured to acquire images and the processor 612 processes the image, before being displayed in the display 614. Dedicated hardware may be used instead of software and/or firmware for performing image processing, or a combination of dedicated hardware and software, or software in combination with a general purpose processor, or a digital signal processor. Once the requirements for such software and/or hardware and/or dedicated hardware are gained from an understanding of the descriptions of embodiments of the invention contained herein, the choice of any particular implementation may be left to a hardware engineer and/or software engineer. However, any dedicated and/or special purpose hardware or special purpose processor is considered subsumed in the block labeled processor 612. The memory 613 is configured to store operating instructions. The processor 612 along with the instructions stored in the memory 613 processes the images. Once the ultrasound imaging device 610 is installed in a network 620, it needs to be configured with different clients in the network 620. The ultrasound imaging device 610 interacts with the network 620 using a data link 625. This facilitates wireless or wired communication of the ultrasound imaging device 610 in the network 620.

A server 640 incorporates a database 645, the database 645 stores configuration information corresponding to all clients present in the network 620. The ultrasound imaging device 610 interacts with the server though a communication link 630. The ultrasound imaging device 610 interact with the server 640 for obtaining configuration information of clients automatically. Upon receiving the configuration information, the clients are configured with the ultrasound imaging device 610.

Some embodiments of the present invention comprise stand-alone workstation computers that include memory, a display, and a processor. The workstation may also include a user input interface (which may include, for example, a mouse, a touch screen and stylus, a keyboard with cursor keys, or combinations thereof). In an embodiment, the ultrasound imaging device may be a stand alone workstation.

The ultrasound imaging device 610 is further configured to include a configuration module 615 and a communication interface 616. The configuration module 615 is a programmable module configured to retrieve the configuration from the server 640 and configure various clients with the ultrasound imaging device 610. The ultrasound imaging device 610 interacts with the network 620 via the communication interface 616.

Whether a stand-alone workstation or an ultrasound imaging device is used, software and/or firmware (hereinafter referred to generically as “software”) can be used to instruct the device to perform the inventive combination of actions described herein. Portions of the software may have specific functions, and these portions are herein referred to as “modules” or “software modules.” However, in some embodiments, may comprise one or more electronic hardware components or special-purpose hardware components that may be configured to perform the same purpose as a software module or to aid in the performance of the software module. Thus, a “module” may also refer to hardware or a combination of hardware and software performing a function.

In an example, an ultrasound imaging device 610 needs to interact with a PACS (not shown) to store the DICOM images. The configuration information of PACS is stored in the database 645. Upon installation, the ultrasound imaging system 610 interacts with the server 640 for the configuration information of the PACS. This might include the identification information of PACS such as IP address, AE title, Port number etc, device setting parameters such as type of images acceptable to PACS such as compression technique, image type such as still or motion image, grouping techniques used etc. The PACS might have certain device settings that also need to be communicated to the ultrasound imaging device 610. Once this configuration information is obtained, the ultrasound imaging device 610 establishes a communication with the PACS. Before sending each image, the image compatibility is negotiated using the PACS device settings and upon confirming the same, each image may be send to the PACS.

In an embodiment, the ultrasound imaging device 610 may need to be configured with different clients in the network 620.

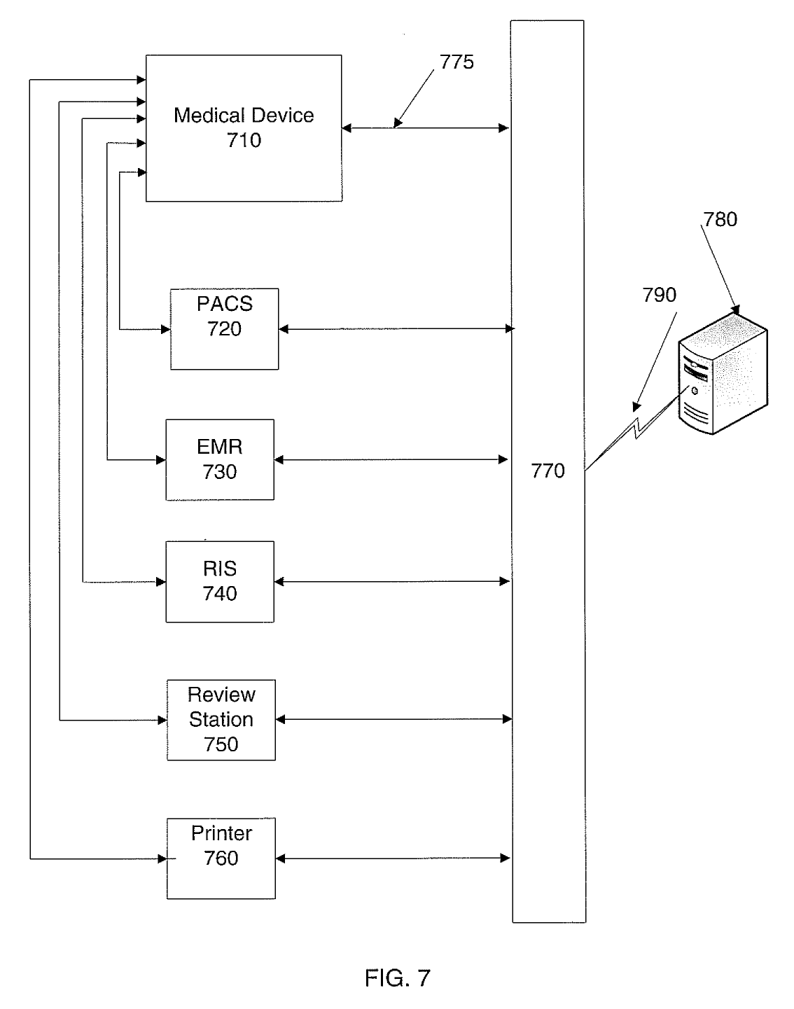

FIG. 7 is a schematic representation of a hospital information system (HIS) having automated configuration facility, as described in an embodiment of the invention. The figure illustrates automatic configuration of a medical device 710 in HIS. The HIS is configured to include various electronic devices/systems tools such as PACS 720, EMR 730, RIS 740, Review workstation 750, and printer 760. However the examples need not be limited to this. All these devices/systems are on a healthcare network 770. These devices/systems are configured to interact with the network 770 through a data link 775. In an embodiment, a medical device 710 is installed into the healthcare network 770. The medical device 710 needs to interact with these devices/systems. For interacting, these devices/systems need to be configured with the medical device 710. Upon installation, the medical device 710 interacts with a server 780, which has a database stored with configuration information corresponding to all the devices/system. The medical device 710 interacts with the server 780 through a communication link 790. The medical device 710 retrieves the configuration information from the server 780 and the same is used in establishing communication with the medical device 710 and one or more devices/systems in the healthcare network 770.

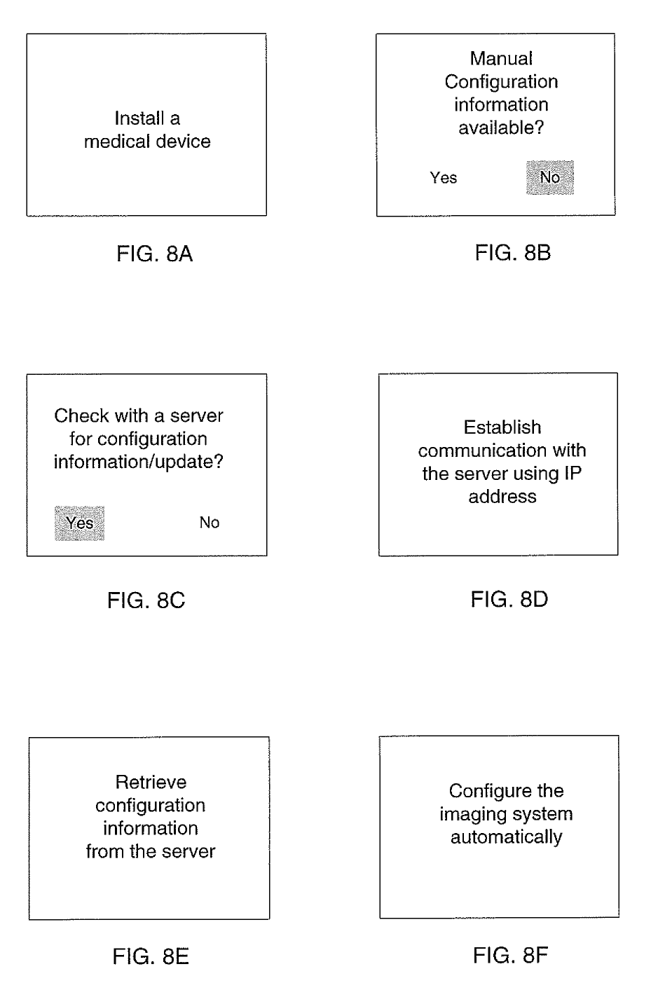

FIGS. 8A to 8F are schematic diagrams illustrating automatic configuration method as described in an embodiment of the invention. The figures illustrate a method of automatically configuring various clients to a medical device. The configuration information of various clients is stored in a database. The database may be located in a remote server. The clients and the medical device are in the same network. In FIG. 8A, a medical device is installed. Once the medical device is installed, the medical device checks whether manual configuration information is available as shown in FIG. 8B. If the clients are going to be configured manually, an administrator may do so. If the manual configuration is not available, the medical device queries, whether it need to interact with a server for obtaining configuration information as shown in FIG. 8C. The medical device may identify a server in the network and the server may have the configuration information corresponding to all the clients present in the network. If not required, preexisting configuration information, may be in the form of templates, stored in the hardware of the medical device may be used in configuring the clients. If the medical device needs to contact the server for configuration information, communication with the server is established using the IP address of the medical device as shown in FIG. 8D. The server has a database stored with the configuration information of all the clients in the healthcare network. The medical device retrieves the configuration information from the server as shown in FIG. 8E. The medical device configures the clients using the configuration information obtained from the server as shown in FIG. 8F.

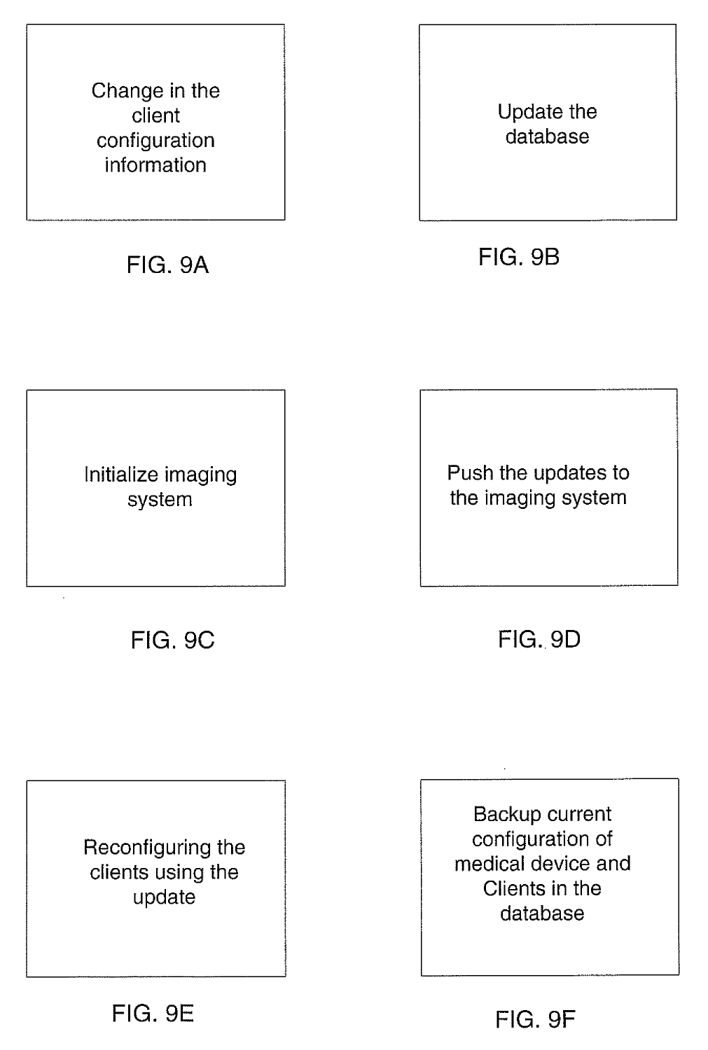

FIGS. 9A to 9F are schematic diagrams illustrating another embodiment of an automatic configuration method. The figures illustrate a method of updating configuration information of various clients in a database. The database may be located in a remote server. The database is being accessed by a medical device to retrieve the configuration information. The clients and the medical device are in the same network. In FIG. 9A, a client configuration is changed. The client itself or an administrator may update the database with the changed configuration information as shown in FIG. 9B. In FIG. 9C, the medical device is initiated. The updated configuration formation is automatically sent to the medical device as shown in FIG. 9D. In FIG. 9E, the clients are reconfigured using the updated configuration information. Optionally, the clients and/or the medical device may interact with the server and take a back up of the current configuration information as shown in FIG. 9F. In an example, backup may be taken at a preset time or interval or may be taken as and when a change in the configuration information is noticed. Thus there will always be a back up of each client and/or medical device's latest configuration information available with the server at any time.

The advantages of the invention include automatically configuring various clients to a medical device in a healthcare network. The human intervention is minimal in configuring and establishing communication between various clients in the network. Further configuring a medical device to communicate with various clients on a healthcare network no longer requires any technical knowledge or presence of a technical person in the healthcare facility. Since the configuration method is automated, the chances of error is minimum and this increases the efficiency of the medical device as well as reduces the turnaround time in configuring and establishing communication among various clients in the healthcare network. Another advantage of the invention is updating a change in the configuration information of one client to various other clients present in the network. Since any update in the configuration information is recorded with the server and the updates are sent automatically to desired clients, it is efficient and less time consuming compared to manual updating of the configuration information with all the clients present in the network. Yet another advantage is automatically taking a backup of current configuration of all the clients and devices present in the network. This will facilitate availability of a backup always with the server, in the event of any system crash or device repair. Thus the configuration of various devices in a healthcare network can be done quickly without the need of a field engineer or technical person and its more cost effective. Also in the event of preset corruption all the clients will be able to restore its configuration information from the server.

Technical effects of embodiments of the present invention include providing a method for auto configuring various clients with a medical device in a healthcare network. Furthermore, some embodiments of the present invention facilitate remotely accessing a database having configuration information, upon installation of a new medical device in a healthcare network. Also in some embodiments, automatic updation of configuration information is provided.

As used herein, an element or step recited in the singular and proceeded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

Exemplary embodiments are described above in detail. The assemblies and methods are not limited to the specific embodiments described herein, but rather, components of each assembly and/or method may be utilized independently and separately from other components described herein. Further the steps involved in the workflow need not follow the sequence in which there are illustrated in figures and all the steps in the work flow need not be performed necessarily to complete the method. Thus, for example, one or more of the functional blocks (e.g., processors or memories) may be implemented in a single piece of hardware (e.g., a general purpose signal processor or a block of random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings. Moreover, the terms “computer” and “processor” are used interchangeably herein to refer to either specialized hardware to perform digital signal processing, control, data manipulation, and/or calculations, or a general purpose computer that can be programmed to perform the same functions and/or adapted to interface with external digital signals. The phrases “computer or processor” and “processor or computer” are therefore intended to have equal scope with either of the individual terms and are not intended to imply a dichotomy between the two terms.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

We claim:

1. A method of establishing communication between a medical device and various clients in a healthcare network comprising:
installing a medical device in a healthcare network;
the medical device accessing a server for obtaining configuration information of at least one client in the network; and
configuring the client with the medical device, using the obtained configuration information.

2. A method as claimed in claim 1, wherein the step of installing includes: identifying the medical device in the network.

3. A method as claimed in claim 1, wherein the step of accessing the server comprises: establishing a communication between the medical device and the server through the network.

4. A method as claimed in claim 3, wherein the step of accessing the server further comprises: checking for configuration information of at least one client from the server.

5. A method as claimed in claim 1, wherein the step of accessing the server comprises: server identifying at least one desired client for the medical device.

6. A method as claimed in claim 4, wherein the step of accessing the server comprises: medical device automatically identifying at least one desired client from the network.

7. A method as claimed in claim 6, wherein the method further comprises: identifying an identification information corresponding to at least one desired client; communicating the identification information corresponding to the identified client to the server; and retrieving the configuration information corresponding to the client from the server.

8. A method as claimed in claim 1, wherein the client includes: DICOM devices and non-DICOM devices.

9. A method as claimed in claim 1, wherein the configuration information includes: configuration workflows for clients and the medical device, configuration updates, client and medical device operating parameters, connectivity settings, and medical device and client device setting parameters.

10. A method as claimed in claim 1, wherein the server is a remote server.

11. A method of configuring various clients with an ultrasound imaging device comprising:
installing an ultrasound imaging device in a healthcare network;
identifying the ultrasound imaging device in the network;
communicating the ultrasound imaging device with a server having a database stored with configuration information corresponding to various clients in the healthcare network;
obtaining the configuration information of at least one desired client of the ultrasound imaging device;
configuring the desired clients with the ultrasound imaging device using the configuration information.

12. A method as claimed in claim 11, wherein the step of communicating includes: checking for configuration information and updates of configuration information of at least one desired client.

13. A method as claimed in claim 12, wherein the step of communicating includes: the server automatically communicating a change in the configuration information to the ultrasound imaging device.

14. A method as claimed in claim 11, wherein the step of obtaining the configuration information for the ultrasound imaging device comprises: communicating the configuration information of the clients that needs to be communicated with the ultrasound imaging device.

15. A method as claimed in claim 14, wherein the step of obtaining configuration information includes: retrieving at least one desired client configuration information or an update in the configuration information from the server.

16. An automatic configuration method comprising:
storing and updating a database with configuration information corresponding to plurality of clients in a healthcare network;
remotely accessing the database by a medical device in the same network to retrieve configuration information corresponding to at least one desired client; and
establishing a communication between the medical device and the desired clients using the configuration information, upon initiating the medical device or the client in the network.

17. An automatic configuration system comprising:
a medical device in a healthcare network having a communication interface configured to allow communication between the medical device and a server;
plurality of clients in the healthcare network that need to be configured with the medical device; and
a storage medium associated with the server, configured to store configuration information corresponding to the clients;
wherein the medical device configures at least one client to the medical device by accessing the storage medium for automatically retrieving configuration information of the clients, upon installation of the medical device.

18. A system as claimed in claim 17, wherein the clients include DICOM and non-DICOM devices

19. A system as claimed in claim 17, wherein the medical device and the clients are configured to update the database with any change in the configuration information.

20. A system as claimed in claim 17, wherein the server is a remote server.

21. A system as claimed in claim 17, wherein the configuration information includes: configuration workflows for clients and the medical device, configuration updates, client and medical device operating parameters, connectivity settings, and medical device and client device settings.

22. An ultrasound imaging device comprising an imager, computer or processor, memory, and a display, the device configured to: automatically configure at least one client in a healthcare network to the ultrasound imaging device in the same network; wherein the device comprises:
a communication interface for establishing a communication with a server having a database stored with configuration information corresponding to various clients in the network; and
a configuration module for configuring the clients with the ultrasound imaging device using the configuration information retrieved from the server.

23. A device as claimed in claim 22, wherein the clients include: Picture Archiving and Communications System (PACS), Electronic Medical Record (EMR), Radiology Information System (RIS), review station and printer.

24. A device as claimed in claim 22, wherein the ultrasound imaging device is configured to receive automatic configuration information updates from the server.
